(19) United States
(12) Patent Application Publication
(10) Pub. No.: US 2023/0164515 A1
(43) Pub. Date: May 25, 2023

(54) ELECTRONIC DEVICE AND METHOD FOR RECOMMENDING USER ACTION BASED ON LOCATION

(71) Applicant: SAMSUNG ELECTRONICS CO., LTD., Suwon-si (KR)

(72) Inventors: Heerok JUNG, Suwon-si (KR); Sangmin KIM, Suwon-si (KR); Soyoung KIM, Suwon-si (KR); Suhyun KIM, Suwon-si (KR); Junseong PARK, Suwon-si (KR); Hyuncheol PARK, Suwon-si (KR)

(21) Appl. No.: 17/983,808

(22) Filed: Nov. 9, 2022

Related U.S. Application Data
(63) Continuation of application No. PCT/KR2022/014693, filed on Sep. 29, 2022.

(30) Foreign Application Priority Data
Nov. 23, 2021 (KR) 10-2021-0162679

(51) Int. Cl. H04W 4/02; H04W 4/33; H04W 4/38

(52) U.S. Cl. CPC H04W 4/025; H04W 4/33; H04W 4/38

(57) ABSTRACT

Various embodiments of the disclose may include a communication module, a sensor module, a memory; and a processor operatively coupled to at least one of the communication module, the sensor module, and the memory, wherein the processor is configured to: collect one or more communication signals through the communication module, predict a location in an indoor space based on the collected communication signals, acquire device state information or a user action through the sensor module at the predicted location, provide a recommendation related to a user based on at least one of the predicted location, the device state information, or the user action.

### CROSS-REFERENCE TO RELATED APPLICATIONS

This application is a continuation of International Application No. PCT/KR2022/014693 designating the United States, filed on Sep. 29, 2022, in the Korean Intellectual Property Receiving Office and claiming priority to Korean Patent Application No. 10-2021-0162679, filed on Nov. 23, 2021, in the Korean Intellectual Property Office, the disclosures of which are incorporated by reference herein in their entireties.

### BACKGROUND

### Field

The disclosure relates to a method and a device for tracking user actions based on predicted locations.

### Description of Related Art

In line with development of digital technologies, there has been widespread use of various kinds of electronic devices such as mobile communication terminals, personal digital assistants (PDA), electronic diaries, smartphones, tablet personal computers, and wearable devices. In order to support and enhance the functionality of such electronic devices, hardware parts and/or software parts of electronic devices have been improved continuously.

For example, electronic devices provide user-tailored functions to users, based on electronic device use patterns of users. For example, electronic devices may determine situations (for example, home, office, before sleep) based on locations and may provide functions (for example, content playback applications) useful for the situations. Respective users have different use patterns, and different functions may be recommended to users in respective situations. Electronic devices may different functions to respective users, thereby improving user convenience.

Users may have electronic device use routines (or patterns) determined at specific locations or times in frequently occupied places (for example, home, offices). A trigger (for example, external device connection or application execution) may be necessary to repeat the same work. Conventional triggering may be inconvenient because users need to manually configure triggers.

### SUMMARY

Embodiments of the disclosure may provide a method and a device for predicting a location in an indoor space, acquiring at least one of time information, device state information, or user action information at the predicted location, thereby collecting a usage pattern, and tracking different user actions according to the location or time, based on the collected usage pattern.

An electronic device according to various example embodiments of the disclosure may include: a communication module including communication circuitry, a sensor module including at least one sensor, a memory, and a processor operatively coupled to at least one of the communication module, the sensor module, and the memory, wherein the processor is configured to: collect one or more communication signals through the communication module, predict a location in an indoor space based on the collected communication signals, acquire device state information or a user action through the sensor module at the predicted location, and provide a recommendation related to a user based on at least one of the predicted location, the device state information, or the user action.

A method for operating an electronic device according to various example embodiments of the disclosure may include: collecting one or more communication signals through a communication module of the electronic device, predicting a location in an indoor space based on the collected communication signals, acquiring device state information or a user action through a sensor module of the electronic device at the predicted location, and providing a recommendation related to a user based on at least one of the predicted location, the device state information, or the user action.

According to various example embodiments, a location may be predicted in an indoor space, and different user actions may be recommended according to a usage pattern collected at the predicted location.

According to various example embodiments, device state information may be collected from sensor information at a predicted location, and user action information may be collected from an application, thereby automatically providing a user action having different device state information or user action information at a different time of collection.

According to various example embodiments, a user action to be performed for a designated time at a designated place is automatically recommended based on a usage pattern without manual configuration by the user, thereby improving user convenience.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a diagram illustrating an example of recommending a user action based on a location by an electronic device according to various embodiments;

FIG. 3 is a flowchart illustrating an example method of operating an electronic device according to various embodiments;

FIG. 4 is a diagram illustrating an example of predicting a location of an indoor space by an electronic device according to various embodiments;

FIGS. 5A, 5B and 5C are diagrams illustrating examples of collecting a use pattern by an electronic device according to various embodiments;

FIG. 6 is a diagram illustrating an example of providing a user action by predicting a location of an indoor space by an electronic device according to various embodiments;

FIG. 7 is a flowchart illustrating an example method of providing a user action by predicting a location by an electronic device according to various embodiments; and

FIG. 8 is a flowchart illustrating an example method of providing a user action by predicting a location by an electronic device according to various embodiments.

### DETAILED DESCRIPTION

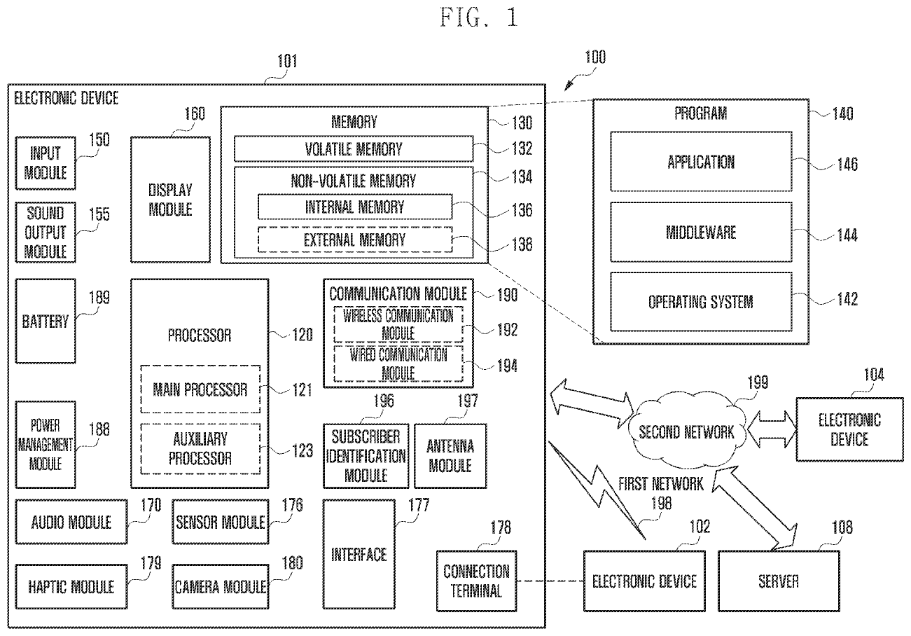

FIG. 1 is a block diagram illustrating an example electronic device 101 in a network environment 100 according to certain embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5th generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to certain embodiments, the antenna module 197 may form a mmWave antenna module. According to an embodiment, the mmWave antenna module may include a printed circuit board, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to certain embodiments may be one of various types of electronic devices. The electronic devices may include, for example, a portable communication device (e.g., a smart phone), a computer device, a portable multimedia device, a portable medical device, a camera, a wearable device, a home appliance, or the like. According to an embodiment of the disclosure, the electronic devices are not limited to those described above.

It should be appreciated that certain embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities, and some of the multiple entities may be separately disposed in different components. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

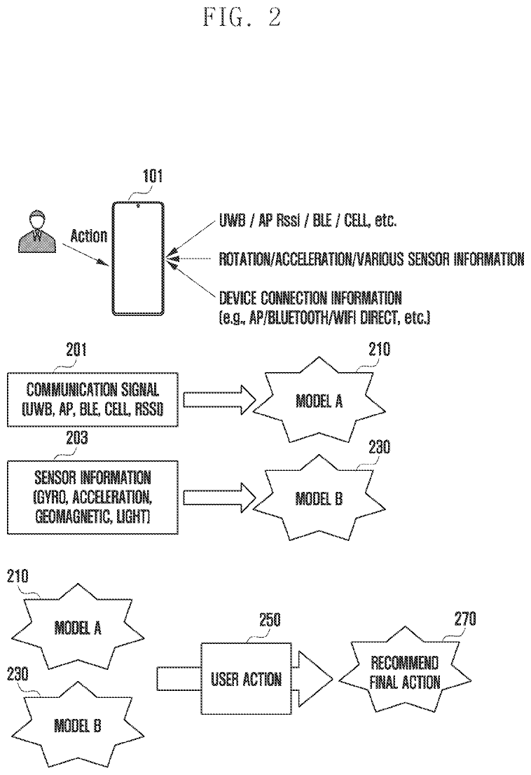

FIG. 2 is a diagram illustrating an example of recommending a user action based on a location by an electronic device according to various embodiments.

Referring to FIG. 2, an electronic device (e.g., the electronic device 101 of FIG. 1) according to various embodiments may be configured to collect (or acquire) at least one of a communication signal, sensor information, and a user action for a configured period of time. The electronic device 101 may be configured to store at least one of the collected communication signal, sensor information, and user action in a memory (e.g., the memory 130 of FIG. 1). The electronic device 101 may be configured to perform learning (e.g., machine learning) at least one of the communication signal, sensor information, and user action having been stored in the memory 130.

For example, the communication signal may correspond to at least one communication method. The communication signal may include at least one of ultra-wide band (UWB), an access point (AP), Bluetooth low energy (BLE), Wi-Fi, Wi-Fi direct, CELL, a received signal strength indicator (RSSI), etc. The electronic device 101 may be configured to collect fingerprints of each communication signal and predict a position (location) in an indoor space (position) based on the collected fingerprints. The fingerprint may include information on the location and signal strength of an external device (e.g., an AP) which transmits a communication signal. For example, when the electronic device 101 and the external device are close to each other, the signal strength is strong, and when the electronic device 101 and the external device are far away, the signal strength may be weak. By building a radio map by collecting each communication signal and the strength of the communication signal, a location in an indoor space may be grasped. A user action may have previously been provided based on geographic locations (e.g., home (Gyeonggi-do), company (Seoul)), whereas the disclosure may provide different user actions by predicting a location in an indoor space.

To this end, the electronic device 101 may be configured to collect communication signals for a configured period of time (e.g., 1 day, 7 days, 30 days, etc.) through a communication module (e.g., the communication module 190 of FIG. 1), and to predict a location in an indoor space based on the collected communication signals. For example, if the indoor space is a house, the location may be divided into room 1, room 2, room 3, a living room, and a kitchen. If the indoor space is an office, the location may be divided into No. 1, No. 2, No. 3, a lounge, and a conference room, for example. The disclosure may predict a rough location based on a communication signal rather than accurately performing location determination. Depending on a location in an indoor space, the collected communication signals may be different, and the signal strength of the collected communication signals may be different. The electronic device 101 may be configured to predict a location based on at least one of the type, the number, and the signal strength of the collected communication signals.

The electronic device 101 may be configured to collect (or acquire) sensor information from a sensor module (e.g., the sensor module 176 of FIG. 1). For example, the sensor module 176 may include various sensors, such as an acceleration sensor, a gyro sensor, a geomagnetic sensor, an illuminance sensor, a barometric pressure sensor, a temperature sensor, etc. The electronic device 101 may be configured to acquire various sensor information measured through the sensor module 176. The electronic device 101 may be configured to store the collected sensor information in the memory 130 and perform learning of the sensor information having been stored in the memory 130.

In addition, the electronic device 101 may be further configured to acquire at least one of device configuration information and device connection information. The electronic device 101 may be configured to store at least one of the collected device configuration information and device connection information in the memory 130, and to perform learning of at least one of the collected device configuration information and device connection information having been stored in the memory 130. The device configuration information may refer to a setting value configured in the electronic device 101, such as brightness or volume of the electronic device 101. The device connection information may be communication information or information on an external device connected to the electronic device 101 by wire or wirelessly. The external device information may include information about an external device, such as a name, an identifier, and a serial number of the external device. The communication information may include information on a communication method by which the external device is connected to the electronic device. The electronic device 101 may be configured to store at least one of the collected device configuration information and device connection information in the memory 130.

The electronic device 101 may be configured to acquire (or collect) a user action. The electronic device 101 may be configured to store the collected user action in the memory 130 and perform learning of the user action stored in the memory 130. The user action may refer to information about an application being executed in the electronic device 101. The application information may refer to a name and an identifier for an application. The electronic device 101 may be configured to store the collected user action in the memory 130.

For example, the electronic device 101 may be configured to predict a location based on a communication signal 201. The electronic device 101 may be configured to determine model A 210 by learning the communication signal 201 through machine learning. The model A 210 may be obtained by learning an action (e.g., a use pattern of the electronic device 101) mainly performed by a user at the predicted location. For example, the electronic device 101 may be configured to perform learning of a use pattern of the electronic device 101 in a first location (e.g., room 1) and a use pattern of the electronic device 101 in a second location (e.g., room 2). Machine learning may include supervised learning or unsupervised learning. The electronic device 101 may be configured to perform learning of the model A 210 at the predicted location through unsupervised learning.

The electronic device 101 may be configured to acquire device state information based on sensor information 203. The electronic device 101 may be configured to determine model B 230 by learning the device state information. The model B 230 may be obtained by learning an action, which is mainly performed by the user, from the acquired device state information. The electronic device 101 may be configured to perform learning of the model B 230 through unsupervised learning based on the device state information. For example, the electronic device 101 may be configured to perform learning of a use pattern of the electronic device 101 when the device state information indicates a first state (e.g., a state in which no change in acceleration is detected), and a use pattern thereof when the device state information indicates a second state (e.g., a state in which an acceleration change is sensed).

The electronic device 101 may be configured to recommend a final action 270 by further considering a user action 250 through the model A 210 or the model B 230. The user action 250 may indicate an application being executed in the electronic device 101 in a case of the model A 210 or model B 230. The electronic 101 may be configured to recommend the final action 270 through supervised learning of the user action 250. The electronic 101 may be configured to recommend the final action 270 by further considering a time (or start time) during which the user action 250 is performed. Accordingly, the electronic device 101 may be configured to provide a routine (or an action) when the learned device state information or user action is detected at the predicted location. The processor 120 may be configured to guide a recommended action (e.g., voice guidance, guidance through a pop-up window, etc.) and execute the action according to a user's input (e.g., execution).

An electronic device (e.g., the electronic device 101 of FIG. 1) according to various example embodiments of the disclosure may include: a communication module including communication circuitry (e.g., the communication module 190 of FIG. 1), a sensor module including at least one sensor (e.g., the sensor module 176 of FIG. 1), a memory (e.g., memory 130 of FIG. 1), and a processor (e.g., the processor 120 of FIG. 1) operatively coupled to at least one of the communication module, the sensor module, and the memory, wherein the processor is configured to: collect one or more communication signals through the communication module, predict a location in an indoor space based on the collected communication signals, acquire device state information or a user action through the sensor module at the predicted location, and provide a recommendation related to a user based on at least one of the predicted location, the device state information, or the user action.

The processor may be configured to: collect fingerprints of each communication signal and predict a location in the indoor space based on the collected fingerprints.

The processor may be configured to: predict a location based on at least one of the type, the number, and the signal strength of the collected communication signals.

The processor may be configured to: acquire device configuration information configured in the electronic device or device connection information regarding connection to the electronic device, and perform learning of at least one of the device configuration information and the device connection information.

The processor may be configured to: acquire time to perform the user action, and recommend a configured action, based on the device state information or user action, having been learned during a configured period of time, being detected at the predicted location.

The processor may be configured to: guide the recommended action and execute the action according to a user input.

The processor may be configured to: recommend different actions b time based on different pieces of device state information or different user actions according to time being acquired at the same location.

The processor may be configured to, as the recommended action, perform connection to an external device or execute a configured application.

The processor may be configured to: collect communication signals for a configured period of time, store the collected communication signals in the memory, and predict a location in the indoor space by learning the stored communication signals.

The processor may be configured to: store the acquired device state information or user action in the memory, and perform learning of the stored device state information or the user action.

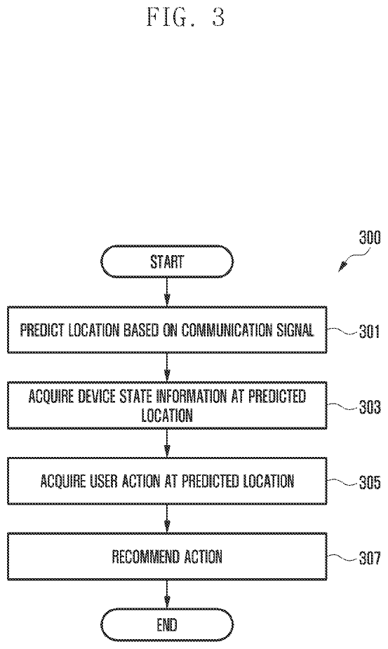

FIG. 3 is a flowchart 300 illustrating an example method of operating an electronic device according to various embodiments.

Referring to FIG. 3, in operation 301, a processor (e.g., the processor 120 of FIG. 1) of an electronic device (e.g., the electronic device 101 of FIG. 1) according to various embodiments may be configured to predict a location based on a communication signal. The communication signal may correspond to at least one communication method. The communication signal may include at least one of UWB, AP, BLE, Wi-Fi, Wi-Fi direct, CELL, RSSI, etc. The processor 120 may be configured to collect communication signals for a configured period of time (e.g., 1 day, 7 days, 30 days, etc.) through a communication module (e.g., the communication module 190 of FIG. 1), and to store the collected communication signals in the memory (e.g., the memory 130 of FIG. 1). The processor 120 may be configured to perform learning of the communication signals stored in the memory 130 and predict a location in an indoor space based on the communication signals. The processor 120 may be configured to collect fingerprints of each communication signal and predict a location in an indoor space based on the collected fingerprints. The processor 120 may use a machine learning technique to predict the location.

For example, if the indoor space is a house, the location may be divided into room 1, room 2, room 3, a living room, and a kitchen. If the indoor space is an office, the location may be divided into No. 1, No. 2, No. 3, a lounge, and a conference room. The disclosure may predict a rough location based on a communication signal rather than accurately performing location determination. Depending on a location in the indoor space, the collected communication signals may be different, and the signal strength of the collected communication signals may be different. The processor 120 may be configured to predict a location based on at least one of the type, the number, and the signal strength of the collected communication signals. For example, in the first location (e.g., room 1), three different types of communication signals (e.g., BLE, AP, CELL) are acquired, and the signal strength of any one communication signal (e.g., BLE) is small, the rest (AP and CELL) may be strong. In the second location (e.g., living room), five types of communication signals (e.g., BLE, AP, UWB, CELL, BT) are acquired, and the strength of three communication signals (e.g., UWB, BLE, AP) is strong, the rest may be small.

In operation 303, the processor 120 may be configured to acquire (or collect) device state information at the predicted location. The processor 120 may be configured to store the collected device state information in the memory 130 and to perform learning of the device state information having been stored in the memory 130. The device state information refers to the state of the electronic device 101 and may be determined by collecting sensor information from a sensor module (e.g., the sensor module 176 of FIG. 1). For example, as the device state information, when no acceleration change is detected by the acceleration sensor, the processor 120 may determine that the electronic device 101 is placed on a desk. As the device state information, when a change in acceleration is detected by the acceleration sensor and rotation is detected by the gyro sensor, the processor 120 may determine that a user holds and uses the electronic device 101. As the device state information, when a change in acceleration, which is detected by the acceleration sensor, has a value exceeding the reference value and a rotation detected by the gyro sensor has a value exceeding the reference value, the processor 120 may determine that the user is moving while holding the electronic device 101.

According to various embodiments, the processor 120 may be further configured to acquire at least one of device configuration information and device connection information at the predicted location. The processor 120 may be configured to store at least one of the collected device configuration information and device connection information in the memory 130, and to perform learning of at least one of the device configuration information and the device connection information having been stored in the memory 130. The device configuration information may refer to a setting value configured in the electronic device 101 such as brightness or volume of the electronic device 101. The device connection information may be communication information or information on an external device connected to the electronic device 101 by wire or wirelessly. The external device information may include information about the external device, such as a name, an identifier, and a serial number of the external device. The communication information may include information on a communication method by which the external device is connected to the electronic device.

In operation 305, the processor 120 may be configured to acquire (or collect) a user action at the predicted location. The processor 120 may be configured to store the collected user actions in the memory 130 and to perform learning of the user actions stored in the memory 130. The user actions may refer to information about an application being executed in the electronic device 101. The application information may refer to a name and an identifier for an application. The processor 120 may also collect a time during which the user action is performed.

In operation 307, the processor 120 may be configured to recommend (or provide) an action (or routine) based on at least one of the predicted location, the device state information, and the user action. For example, when first device state information is detected (e.g., acceleration and rotation detection) and a first user action (e.g., a game application) is acquired at the predicted first location (e.g., room 2), the processor 120 may be configured to recommend a first action (e.g., execution of the game application). When second device state information (e.g., acceleration and rotation not detected) is detected and a first user action (e.g., a video streaming application) is acquired at the predicted second location (e.g., room 3), the processor 120 may be configured to recommend a second action (e.g., connection to a TV and execution of a video streaming application). The processor 120 may be configured to guide a recommended action (e.g., voice guidance, guidance through a pop-up window, etc.) and execute the action according to a user input (e.g., execution).

According to various embodiments, the user may charge the electronic device 101 while placing the electronic device 101 on the desk before going to sleep. In this case, the processor 120 may be configured to detect the state of charge rather than acceleration and rotation detection. The processor 120 may lower the brightness of the electronic device 101, change the electronic device 101 to a mute mode, or change the electronic device 101 to a power saving mode (or function, process), based on at least one of the predicted location, time, the device state information, and the user action. When an alarm configured by the user sounds and it is determined that the user is using the electronic device 101 (e.g., acceleration and rotation detection), the processor 120 may be configured to change the brightness, volume, or mode of the electronic device 101 to those of the previous state.

According to various embodiments, when different pieces of device state information or user actions according to time are acquired at the same location, the processor 120 may be configured to recommend different actions according to time. For example, at a first location, during a first time (e.g., 6 pm), second device state information (e.g., acceleration and rotation not detected and speaker connected) and a second user action (e.g., a music playback application) may be acquired, and during a second time (e.g., 11 pm), third device state information (e.g., acceleration and rotation detected) and a third user action (e.g., a search application) may be acquired. In this case, the processor 120 may be configured to recommend a first action (e.g., execution of a music playback application and connection to a speaker) during the first time, and provide a second action (e.g., execution of a search application) during the second time.

Although the drawing illustrates that the location is predicted and the device state information or the user action is obtained, the operations of predicting the location and obtaining the device state information or the user action may be performed simultaneously or in any order. For example, operations 301 to 305 may be performed simultaneously or may be performed in any order. The processor 120 may perform operation 307 based on operations 301 to 305.

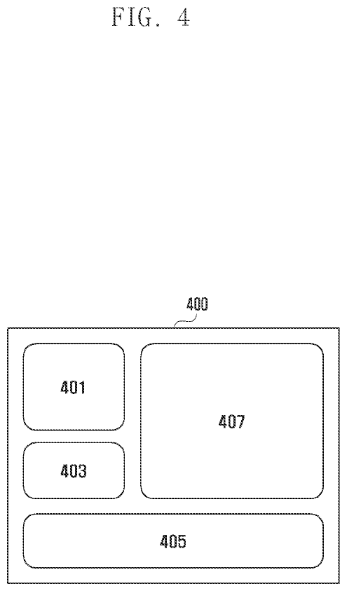

FIG. 4 is a diagram illustrating an example of predicting a location of an indoor space by an electronic device according to various embodiments.

Referring to FIG. 4, a processor (e.g., the processor 120 of FIG. 1) of an electronic device (e.g., the electronic device 101 of FIG. 1) according to various embodiments may be configured to predict a location in an indoor space 400 based on a communication signal. For example, the indoor space 400 may be divided into a first location 401, a second location 403, a third location 405, and a fourth location 407. The processor 120 may be configured to divide the indoor space 400 into a first location 401 to a fourth location 407 based on a communication signal collected for a configured period of time. In the indoor space 400, different communication signals may be collected depending on the location, and the signal strength of the collected communication signals may be different. The processor 120 may be configured to collect fingerprints of each communication signal and predict a location in an indoor space based on the collected fingerprints.

For example, at the first location 401, communication signals having the largest strength may be collected, and at the second location 403, the smallest number of communication signals are collected (e.g., only AP and CELL are acquired) and communication signals having the smallest signal strength may be collected. AP and BLE signals may be collected at the third location 405, and UWB, AP, BLE, CELL, or RSSI may all be collected at the fourth location 407. The processor 120 may be configured to predict a location in the indoor space 400 based on at least one of the type, the number, and the signal strength of the collected communication signals.

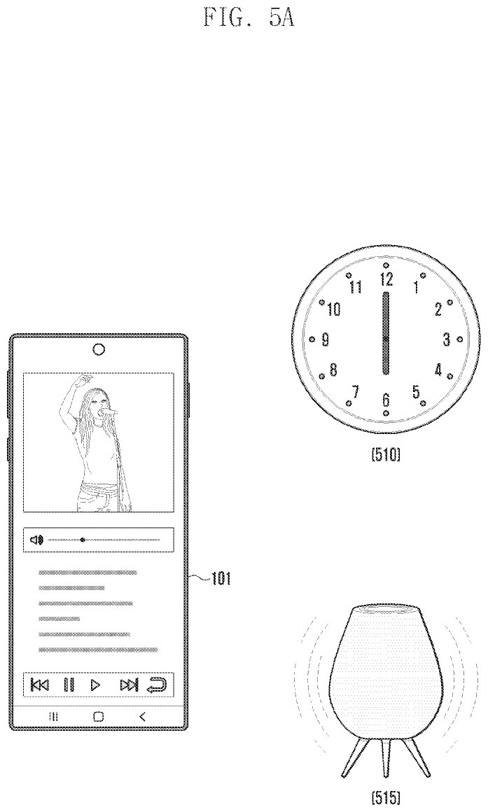

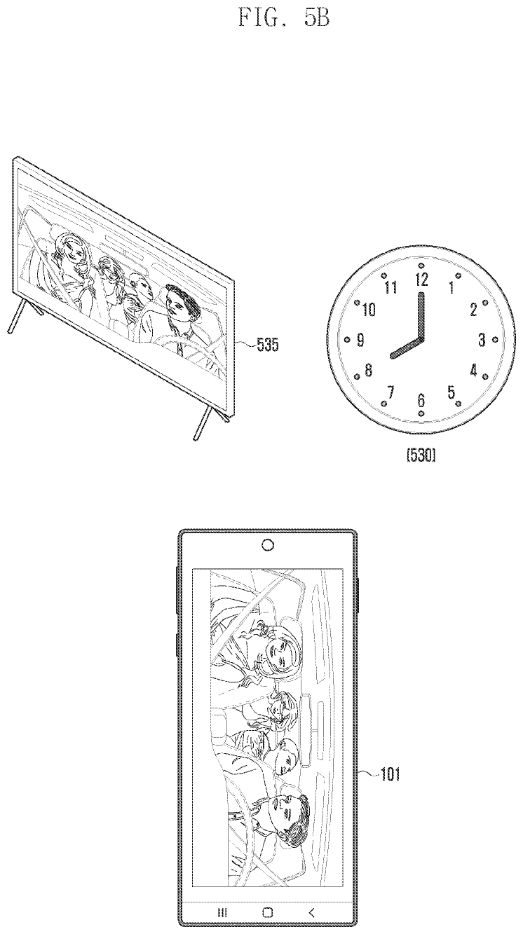

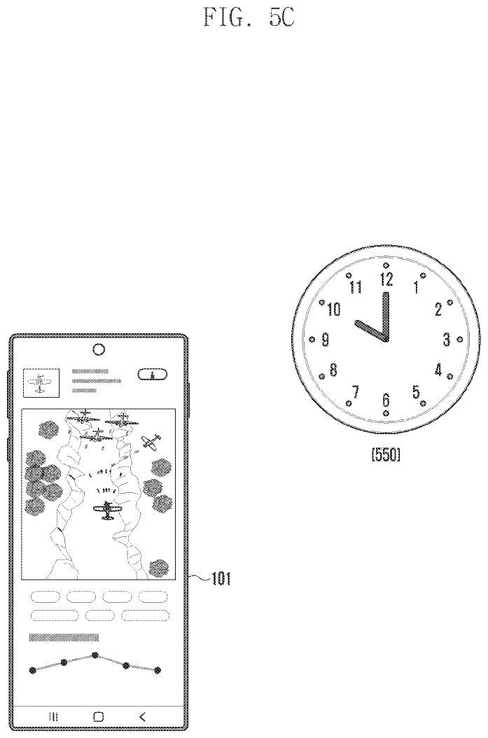

FIGS. 5A, 5B and 5C are diagrams illustrating examples of collecting a use pattern by an electronic device according to various embodiments.

FIG. 5A illustrates an example of collecting first device state information and a first user action by an electronic device.

Referring to FIG. 5A, a processor (e.g., the processor 120 of FIG. 1) of an electronic device (e.g., the electronic device 101 of FIG. 1) according to various embodiments may be configured to acquire (or collect) first device state information and a first user action at a predicted location (e.g., the first location 401 of FIG. 4). The first device state information may include information indicating that no change in acceleration is detected by an acceleration sensor and no rotation is detected by a gyro sensor. For example, when the electronic device 101 is placed on a desk or shelf, there may be no change in acceleration or no rotation may be detected. In connection with the first device state information, the processor 120 may be further configured to acquire at least one of device configuration information and device connection information. In connection with the first device state information, the electronic device 101 may be connected to a speaker 515 through Bluetooth (or Bluetooth low energy), as the device connection information.

In addition, the first user action may be in a state of executing a music application. An execution screen of the music application may be displayed on the display of the electronic device 101 (e.g., the display module 160 of FIG. 1). The processor 120 may be further configured to acquire a time during which the first user action is performed (e.g., a first time 510). The processor 120 may be configured to acquire device state information at a location in which the first user action is performed or when the first user action is performed. The operations of predicting the location, and acquiring the device state information or user action may be performed simultaneously or in any order.

For example, when the first time 510 comes, at the first location 401 (e.g., room 1), the user may connect the electronic device 101 to the speaker 515 and execute a music application so as to allow music to be output through the speaker 515. After connecting the speaker 515 and executing the music application, the user may place the electronic device 101 on a table. The processor 120 may be configured to predict a location and to perform learning of the first device state information or first user action at the predicted location. Thereafter, when it is determined that the electronic device 101 has moved to the first location 401 during the first time 510, the processor 120 may be configured to perform connection to the speaker 515 and execute a music playback application. The processor 120 may be configured to provide a predetermined (e.g., specified) action (e.g., connection to the speaker 515 and execution of the music playback application) without user intervention.

FIG. 5B illustrates an example of collecting second device state information and a second user action by the electronic device.

Referring to FIG. 5B, the processor 120 may be configured to acquire (or collect) second device state information and a second user action at a predicted location (e.g., the fourth location 407 of FIG. 4). The second device state information may include information indicating that no acceleration change is detected by an acceleration sensor and no rotation is detected by a gyro sensor. For example, when the electronic device 101 is placed on a desk or shelf, there may be no change in acceleration or no rotation detected. In connection with the second device state information, the processor 120 may be further configured to acquire at least one of device configuration information and device connection information. In connection with the second device state information, the electronic device 101 may be connected to TV 535 through Bluetooth (or Bluetooth low energy), as the device connection information.

In addition, the second user action may be in a state of executing a video streaming application. An execution screen of a video streaming application may be displayed on the display module 160. The processor 120 may be further configured to acquire a time during which the second user action is performed (e.g., a second time 530). The processor 120 may be configured to acquire device state information at a location in which the second user action is performed or when the second user action is performed. The operations of predicting a location and obtaining device state information or a user action may be performed simultaneously or in any order.

For example, when the second time 530 comes, at the fourth location 407 (e.g., living room), the user may connect the electronic device 101 to the TV 535 and execute a video streaming application so as to allow the video streaming application to be displayed (e.g., mirrored) on the TV 535. When mirroring is completed, the user may place the electronic device 101 on the living room table and sit on the sofa. The processor 120 may be configured to predict a location and to perform learning of second device state information or a second user action at the predicted location. Thereafter, when the electronic device 101 is placed at the fourth location 407 during the second time 530 and is connected to the TV 535, the processor 120 may be configured to execute a video streaming application. Alternatively, when it is determined that the electronic device 101 has moved to the fourth location 407 during the second time 530, the processor 120 may be configured to perform connection to the TV 535 and execute the video streaming application. The processor 120 may provide a predetermined action (e.g., connection to the TV 535 and execution of the video streaming application) without user intervention.

FIG. 5C illustrates an example of collecting third device state information and a third user action by the electronic device.

Referring to FIG. 5C, the processor 120 may be configured to acquire (or collect) third device state information and a third user action at a predicted location (e.g., the fourth location 407 of FIG. 4). The third device state information may include information indicating that a change in acceleration is detected by an acceleration sensor and rotation is detected by a gyro sensor. For example, when a user holds and uses the electronic device 101, an acceleration change may be detected or a rotation may be detected. In connection with the third device state information, the processor 120 may be further configured to acquire at least one of device configuration information and device connection information.

In addition, the third user action may be in a state of executing a game application. An execution screen of a game application may be displayed on the display module 160. The processor 120 may be further configured to acquire a time during which the third user action is performed (e.g., a third time 550). The processor 120 may be configured to acquire device state information at a location in which the third user action is performed or when the third user action is performed. The operations of predicting a location and obtaining the device state information or user action may be performed simultaneously or in any order.

For example, when the third time 550 comes, at the fourth location 407, the user may play a game while holding the electronic device 101. The processor 120 may be configured to predict a location and to perform learning of the third device state information or third user action at the predicted location. Thereafter, when the electronic device 101 is located at the fourth location 407 during the third time 550, the processor 120 may be configured to execute the game application. The processor 120 may be configured to provide a predetermined action (e.g., execution of a game application) without user intervention.

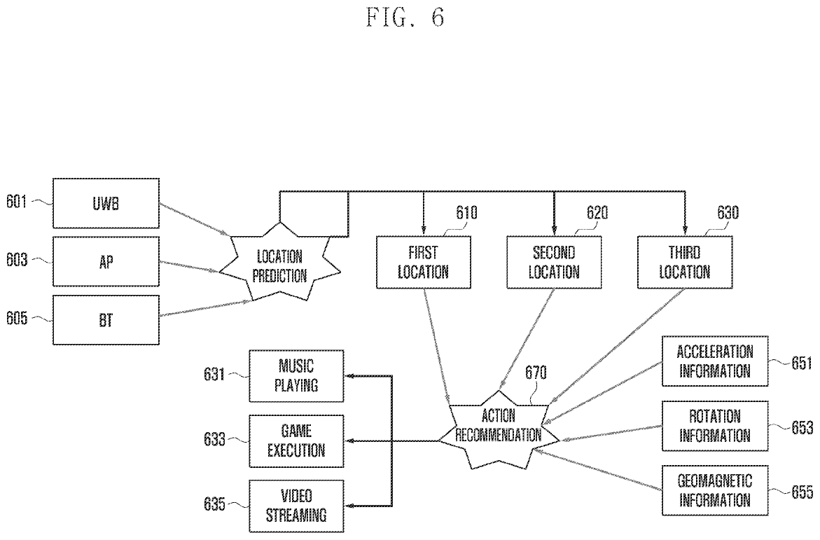

FIG. 6 is a diagram illustrating an example of providing a user action by predicting a location of an indoor space by an electronic device according to various embodiments.

Referring to FIG. 6, a processor (e.g., the processor 120 of FIG. 1) of an electronic device (e.g., the electronic device 101 of FIG. 1) according to various embodiments may be configured to collect communication signals for a configured period of time, store the collected communication signals in a memory (e.g., the memory 130 of FIG. 1), and predict a location based on the stored communication signals. For example, the communication signal may include a UWB 601, an AP 603, and a BT 605. The communication signal may further include other communication signals (e.g., BLE, CELL, etc.) not shown. The processor 120 may be configured to collect fingerprints of each communication signal and predict a location in an indoor space based on the collected fingerprints. For example, the processor 120 may build a wireless map including at least one of a first location 610, a second location 620, and a third location 630 based on each communication signal.

In addition, the processor 120 may be configured to collect user actions for a configured period of time period, store the collected user actions in the memory 130, and perform learning of the stored user actions. The user action may refer to information about an application being executed in the electronic device 101. For example, the user action may include music playing 631, game execution 633, or video streaming 635.

In addition, the processor 120 may be configured to collect device state information for a configured period of time period, store the collected device state information in the memory 130, and perform learning of the stored device state information. The device state information may include various sensor information from the sensor module. For example, the device state information may include at least one of acceleration information 651 detected (or acquired) by an acceleration sensor, rotation information 653 detected (or acquired) by a gyro sensor, or geomagnetic information 655 detected (or acquired) by a geomagnetic sensor. The device state information may further include other device state information (e.g., illuminance information) not shown. The processor 120 may be configured to collect device configuration information or device connection information for a configured period of time, store the collected device configuration information or device connection information in the memory 130, and perform learning of the stored device configuration information or device connection information.

The processor 120 may be configured to recommend an action 670 based on at least one of the location, time, user action, and device state information. The processor 120 may be configured to collect location, time, user action, or device state information, respectively, perform learning of the collected information, synthesize the learned information, and finally recommend an action (indicted by reference numeral 670).

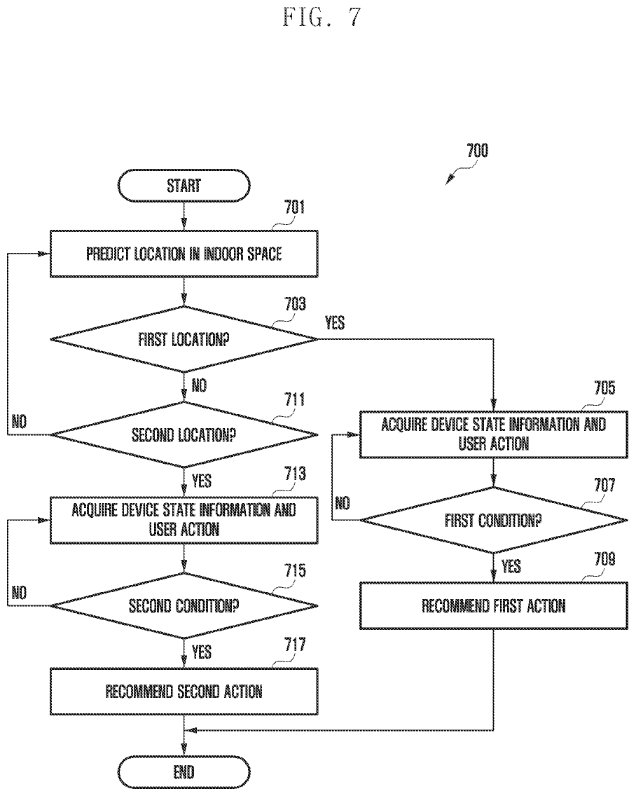

FIG. 7 is a flowchart 700 illustrating an example method of providing a user action by predicting a location by an electronic device according to various embodiments. FIG. 7 may illustrate an example of an operation of recommending an action after performing learning about a location, a user action, and device state information for a configured period of time.

Referring to FIG. 7, in operation 701, a processor (e.g., the processor 120 of FIG. 1) of an electronic device (e.g., the electronic device 101 of FIG. 1) according to various embodiments may be configured to predict a location in an indoor space. The processor 120 may be configured to acquire a communication signal at a location (or current location) of the electronic device 101 through a communication module (e.g., the communication module 190 of FIG. 1), and based on the acquired communication signal, predict at least one location according to a machine learning technique which has been previously performed. The processor 120 may be configured to predict a location based on at least one of the type, the number, and the signal strength of the collected communication signals.

In operation 703, the processor 120 may be configured to determine whether the location (or current location) of the electronic device 101 corresponds to (or satisfies) a first location. The processor 120 may be configured to perform operation 705 when the location of the electronic device 101 corresponds to the first location, and perform operation 711 when the location of the electronic device 101 does not correspond to the first location.

When the location of the electronic device 101 corresponds to the first location, the processor 120 may be configured to acquire device state information and a user action in operation 705. The device state information may be determined by collecting sensor information obtained from a sensor module (e.g., the sensor module 176 of FIG. 1). As the device state information, when no acceleration change is detected by the acceleration sensor, the processor 120 may determine that the electronic device 101 is placed on a desk (e.g., a fixed state or a stationary state). When one direction is detected by the geomagnetic sensor and is not changed, the processor 120 may be configured to determine the device state information as a fixed state. The user action may refer to information about an application being executed in the electronic device 101. The processor 120 may also acquire a time during which the user action is performed.

According to various embodiments, the processor 120 may be further configured to acquire device configuration information or device connection information. The device configuration information may refer to a setting value configured in the electronic device 101, such as brightness or volume of the electronic device 101. The device connection information may be communication information or information on an external device connected to the electronic device 101 by wire or wirelessly.

In operation 707, the processor 120 may be configured to determine whether the acquired device state information and user action correspond to the first condition. The first condition may include at least one of a first location (e.g., room 1), a first time (e.g., 6 pm), a first state (e.g., no acceleration or rotation is detected), or connection to a speaker. The processor 120 may be configured to perform operation 709 when the acquired device state information and user action correspond to the first condition, and return to operation 705 when the acquired device state information and user action do not correspond to the first condition. When returning to operation 705, the processor 120 may be configured to continuously acquire the device state information and user action, and determine whether the acquired device state information and user action correspond to the first condition.

When the acquired device state information and user action correspond to the first condition, the processor 120 may be configured to recommend a first action in operation 709. For example, the processor 120 may execute a music playback application, as the first action. The processor 120 may be configured to perform connection to a speaker and execute the music playback application, as the first action. The processor 120 may be configured to guide the first action (e.g., voice guidance, guidance through a pop-up window, etc.) and execute the first action according to a user input (e.g., execution).

When the location of the electronic device 101 does not correspond to the first location, the processor 120 may be configured to determine whether the location of the electronic device 101 corresponds to the second location in operation 711. The processor 120 may be configured to perform operation 713 when the location of the electronic device 101 corresponds to the second location, and return to operation 701 when the location of the electronic device 101 does not correspond to the second location. When returning to operation 701, the processor 120 may be configured to predict the location of the electronic device 101 based on the communication signal, acquire the device state information and user action at the predicted location, and recommend an action when a configured condition is satisfied.

When the location of the electronic device 101 corresponds to the second location, the processor 120 may be configured to acquire device state information and a user action in operation 713. As the device state information, when a change in acceleration is detected by the acceleration sensor and rotation is detected by the gyro sensor, the processor 120 may determine that the user is holding and using the electronic device 101. The user action may refer to information about an application being executed in the electronic device 101. The processor 120 may also acquire a time during which the user action is performed. Since operation 713 is the same as or similar to operation 705, a detailed description thereof may not be repeated.

In operation 715, the processor 120 may be configured to determine whether the acquired device state information and user action correspond to the second condition. The second condition may include at least one of a second location (e.g., living room), a second time (e.g., 8 pm), a second state (e.g., acceleration or rotation is detected), and connection to a TV. The processor 120 may be configured to perform operation 717 when the acquired device state information and user action correspond to the second condition, and return to operation 713 when the acquired device state information and user action do not correspond to the second condition. When returning to operation 713, the processor 120 may be configured to continuously acquire device state information and user action, and determine whether the acquired device state information and user action correspond to the second condition.

When the acquired device state information and user action correspond to the second condition, the processor 120 may be configured to recommend a second action in operation 717. For example, the processor 120 may execute a video streaming application, as the second action. The processor 120 may be configured to perform connection to the TV and execute a video streaming application, as the second action. The processor 120 may be configured to guide the second action (e.g., voice guidance, guidance through a pop-up window, etc.) and execute the second action according to a user input (e.g., execution).

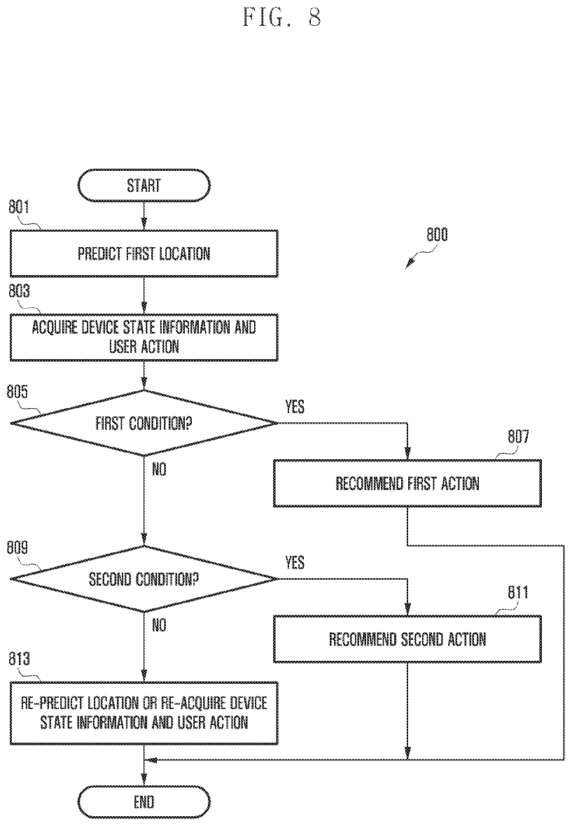

FIG. 7 may illustrate an example in which one action is performed at the same location. Hereinafter, FIG. 8 may illustrate an example in which one or more actions are performed at the same location.

FIG. 8 is a flowchart 800 illustrating an example method of providing a user action by predicting a location by an electronic device according to various embodiments. FIG. 8 may illustrate an example of an operation of recommending an action after performing learning about a location, a user action, and device state information for a configured period of time.

Referring to FIG. 8, in operation 801, a processor (e.g., the processor 120 of FIG. 1) of an electronic device (e.g., the electronic device 101 of FIG. 1) according to various embodiments may be configured to predict the location thereof as a first location. The processor 120 may be configured to acquire a communication signal at a location (or current location) of the electronic device 101, and predict the location thereof as the first location based on the acquired communication signal according to a machine learning technique which has been previously performed. The processor 120 may be configured to predict a location based on at least one of the type, number, and signal strength of the collected communication signals.

In operation 803, the processor 120 may be configured to acquire device state information and a user action. The device state information may be determined by collecting sensor information obtained from a sensor module (e.g., the sensor module 176 of FIG. 1). As the device state information, when a change in acceleration, which is detected by the acceleration sensor, has a value equal to or greater than the reference value and a rotation, which is detected by the gyro sensor, has a value equal to or greater than the reference value, the processor 120 may determine that the user is moving (e.g., in a moving state) while holding the electronic device 101. The user action may refer to information about an application being executed in the electronic device 101. The processor 120 may also acquire a time during which the user action is performed.

According to various embodiments, the processor 120 may be further configured to acquire device configuration information or device connection information. The device configuration information may refer to a setting value configured in the electronic device 101, such as brightness or volume of the electronic device 101. The device connection information may be communication information or information on an external device connected to the electronic device 101 by wire or wirelessly.

In operation 805, the processor 120 may be configured to determine whether the acquired device state information and user action correspond to the first condition. The first condition may include at least one of a second location (e.g., living room), a third time (e.g., 8 pm), and a third state (e.g., moving state). The processor 120 may be configured to perform operation 807 when the acquired device state information and user action correspond to the first condition, and perform operation 809 when the acquired device state information and user action do not correspond to the first condition.

When the acquired device state information and user action correspond to the first condition, the processor 120 may be configured to recommend a first action in operation 807. For example, the processor 120 may execute a game application, as the first action. The processor 120 may be configured to guide the first action (e.g., voice guidance, guidance through a pop-up window, etc.) and execute the first action according to a user input (e.g., execution).

When the acquired device state information and user action do not correspond to the first condition, the processor 120 may be configured to determine whether the acquired device state information and user action correspond to the second condition in operation 809. When the user performs different actions according to time at the same location, the processor 120 may be configured to determine whether the acquired device state information and user action correspond to the second condition when the acquired device state information and user action do not correspond to the first condition. At the same location, at least one of time, device state information, or user action of the first condition may be different from those of the second condition. For example, the second condition may include at least one of a second location (e.g., living room), a fourth time (e.g., 10 pm), and a fourth state (e.g., a state of holding and using the electronic device 101).

Although the flowchart illustrates that the first condition is identified first and the second condition is identified later, the second condition may be identified first and the first condition may be identified later, or the first condition and the second condition may be identified at the same time. This is only an implementation issue, and the disclosure is not limited by the drawings.

The processor 120 may be configured to perform operation 811 when the acquired device state information and user action correspond to the second condition, and perform operation 813 when the acquired device state information and user action do not correspond to the second condition.

When the acquired device state information and user action correspond to the second condition, the processor 120 may be configured to recommend a second action in operation 811. For example, the processor 120 may execute an Internet cartoon application, as the second action. The processor 120 may be configured to guide the second action (e.g., voice guidance, guidance through a pop-up window, etc.) and execute the second action according to a user input (e.g., execution).

When the acquired device state information and user action do not correspond to the second condition, the processor 120 may be configured to re-predict a location or re-acquire device state information or a user action in operation 813. According to information obtained by learning the device state information and user action, the processor 120 may be configured to determine whether the device state information and user action correspond to a different condition at the same location, and when neither the device state information nor the user action satisfies the learned conditions, the processor may determine that the location prediction is wrong. The processor 120 may re-predict a location in an indoor space based on a communication signal, and acquire device state information or a user action at the predicted location.

The processor 120 may determine whether the device state information and user action correspond to a different condition at the same location according to the learned information, and when neither the device state information nor the user action satisfies the learned conditions, the processor may determine that the correct device state information has not been obtained due to an error in the sensor module 176. In this case, the processor 120 may be configured to re-acquire the device state information or the user action.

A method for operating an electronic device (e.g., the electronic device 101 of FIG. 1) according to various example embodiments of the disclosure may include: collecting one or more communication signals through a communication module (e.g., the communication module 190 of FIG. 1) of the electronic device, predicting a location in an indoor space based on the collected communication signals, acquiring device state information or a user action through a sensor module (the sensor module 176 of FIG. 1) of the electronic device at the predicted location; and providing a recommendation related to a user based on at least one of the predicted location, the device state information, or the user action.

The collecting and the predicting may include: collecting fingerprints of each communication signal, and predicting a location in an indoor space based on the collected fingerprints.

The predicting may include predicting a location based on at least one of the type, the number, and the signal strength of the collected communication signals.

The method may further include: acquiring device configuration information configured in the electronic device or device connection information regarding connection to the electronic device, and performing learning of at least one of the device configuration information and the device connection information.

The method may further include acquiring a time to perform the user action, and the providing may further include recommending a configured action based on the device state information or user action, having been learned during a configured period of time, being detected at the predicted location.

The method may further include guiding the recommended action and executing the action according to an input.

The providing may include recommending different actions according to time based on different pieces of device state information or different user actions according to time being acquired at the same location.

The providing may include performing connection to an external device or executing a configured application, as the recommend action.

The collecting and the predicting may include: storing the communication signal having been collected for a configured period of time in a memory of the electronic device, and predicting a location in an indoor space by learning the stored communication signals.

The method may further include: storing the acquired device state information or user action in the memory, and performing learning of the stored device state information or the user action.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a communication module comprising communication circuitry;
a sensor module comprising at least one sensor;
a memory; and
a processor operatively coupled to at least one of the communication module, the sensor module, and the memory,
wherein the processor is configured to:
collect one or more communication signals through the communication module;
predict a location in an indoor space based on the collected communication signals;
acquire device state information or a user action through the sensor module at the predicted location; and
provide a recommendation related to a user based on at least one of the predicted location, the device state information, or the user action.

2. The electronic device of claim 1, wherein the processor is configured to:
collect fingerprints of each communication signal; and
predict the location in the indoor space based on the collected fingerprints.

3. The electronic device of claim 1, wherein the processor is configured to predict a location based on at least one of a type, number, and signal strength of the collected communication signals.

4. The electronic device of claim 1, wherein the processor is configured to:
acquire device configuration information configured in the electronic device or device connection information regarding connection to the electronic device; and
learn at least one of the device configuration information and the device connection information.

5. The electronic device of claim 1, wherein the processor is configured to:
acquire a time to perform the user action; and
recommend a configured action based on the device state information or user action, having been learned during a configured period of time, being detected at the predicted location.

6. The electronic device of claim 1, wherein the processor is configured to guide the recommended action and execute the action based on an input.

7. The electronic device of claim 1, wherein the processor is configured to recommend different actions according to time based on different pieces of device state information or different user actions according to time being acquired at the same location.

8. The electronic device of claim 1, wherein the processor is configured to, as the recommended action, perform connection to an external device or execute a configured application.

9. The electronic device of claim 1, wherein the processor is configured to:
collect communication signals for a specified period of time;
store the collected communication signals in the memory; and
predict a location in the indoor space by learning the stored communication signals.

10. The electronic device of claim 1, wherein the processor is configured to:
store the acquired device state information or user action in the memory; and
perform learning of the stored device state information or the user action.

11. A method of operating an electronic device, the method comprising:
collecting one or more communication signals through a communication module of the electronic device;
predicting a location in an indoor space based on the collected communication signals;
acquiring device state information or a user action through a sensor module of the electronic device at the predicted location; and
providing a recommendation related to a user based on at least one of the predicted location, the device state information, or the user action.

12. The method of claim 11, wherein the collecting and the predicting comprise:
collecting fingerprints of each communication signal; and
predicting a location in the indoor space based on the collected fingerprints.

13. The method of claim 11, wherein the predicting comprises predicting a location based on at least one of a type, number, and signal strength of the collected communication signals.

14. The method of claim 11, further comprising:
acquiring device configuration information configured in the electronic device or device connection information regarding connection to the electronic device; and
performing learning of at least one of the device configuration information and the device connection information.

15. The method of claim 11, further comprising acquiring a time to perform the user action,
wherein the providing comprises recommending a configured action based on the device state information or user action, having been learned during a configured period of time, being detected at the predicted location.

16. The method of claim 11, further comprising guiding the recommended action and executing the action according to a user input.

17. The method of claim 11, wherein the providing comprises recommending different actions according to time based on different pieces of device state information or different user actions according to time being acquired at the same location.

18. The method of claim 11, wherein the providing comprises performing connection to an external device or executing a configured application, as the recommend action.

19. The method of claim 11, wherein the collecting and the predicting comprise:
storing the communication signal having been collected for a specified period of time in the memory; and
predicting a location in the indoor space by learning the stored communication signals.

20. The method of claim 11, further comprising:
storing the acquired device state information or user action in the memory, and
performing learning of the stored device state information or the user action.
